(19) United States
(12) Patent Application Publication
(10) Pub. No.: US 2021/0078241 A1
(43) Pub. Date: Mar. 18, 2021

(54) MACHINE TO BUILD 3 DIMENSIONAL OBJECTS

(71) Applicant: Densen Cao, Sandy, UT (US)

(72) Inventor: Densen Cao, Sandy, UT (US)

(21) Appl. No.: 16/328,359

(22) PCT Filed: Aug. 29, 2017
(86) PCT No.: PCT/US2017/049014

§ 371 Date: Feb. 26, 2019

Related U.S. Application Data
(60) Provisional application No. 62/381,086, filed on Aug. 30, 2016.

(51) Int. Cl. B29C 64/106; B33Y 30/00; B29C 64/264

(52) U.S. Cl. CPC B29C 64/106; B29C 64/264; B33Y 30/00

(57) ABSTRACT

A machine to build 3 dimensional objects using light cured materials.

### CROSS-REFERENCES TO RELATED APPLICATIONS

This application claims the benefit of U.S. Provisional Application No. 62/381,086 filed on Aug. 30, 2016, which is hereby incorporated by reference in its entirety.

This application claims the benefit of PCT Application No. PCT/US17/49014, filed Aug. 29, 2017, which is a non-provisional of U.S. Provisional Patent Application No. 62/381,086 filed on Aug. 30, 2016, each of which is hereby incorporated by reference in its entirety.

### TECHNICAL FIELD OF THE INVENTION

The present invention discloses a machine to use a light cured material dispensed by an air driven syringe.

### BACKGROUND OF THE INVENTION

There are many machines available on the market to build a prototype 3 dimensional part using plastic or other type of materials. There are following problems for existing machines on the market: 1). Too expensive; 2). Take a long time to build a part; 3). Waste in materials

### SUMMARY OF THE INVENTION

The invention discloses a machine to use a light cured material dispensed by an air driven syringe which is moved in three dimensions for making 3 dimension objects based on the design file. The invented machine can achieve following goals: 1). Economical; 2). Fast; and 3). No material waste.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

FIG. 1 depicts an isometric view of a machine to make 3 dimensional objects according to an embodiment of the invention.

### DETAILED DESCRIPTION OF THE INVENTION

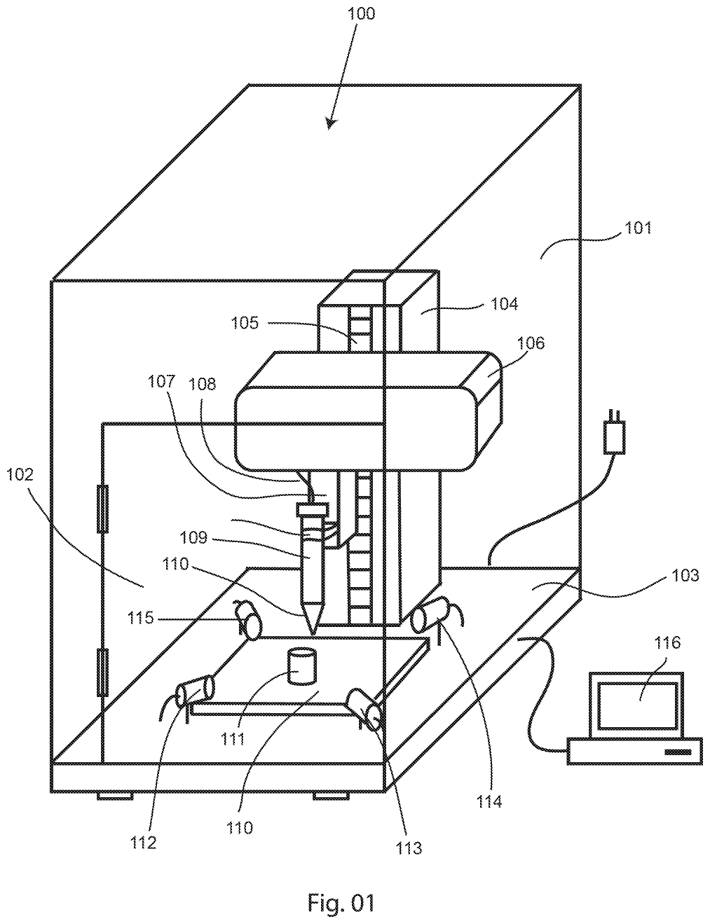

FIG. 1 depicts the invented machine 100 is the machine to make 3 dimensional objects. 101 is a case, 102 is a door to access to inner machine, 103 is a base, 104 is a shaft for vertical moment of delivery syringe, 105 is a control box and can move the delivery syringe in x, y and z directions, 106 is a holder for syringe, 107 is an air input for the delivery syringe, 108 is the syringe holding the dispense material, 109 is the dispense tip, 110 is the base plate that the material will be dispensed on, 110 is the dispense object, 112, 113, 114, and 115 are the light source to emit the light to cure the materials dispensed from the syringe, 116 is a computer to input the design file to the control box 105.

The machine works as followings: load the syringe with proper material and dispense tip, load the design file to control box, the control box controls the movement and dispense rate of syringe to the base plate based on the 3 dimensional design, the lights from light sources will be on when the material is dispensed, the materials is cured as soon as it is dispensed. The object is ready for use after complete dispense based on the design.

What is claimed is:

1. A machine to build 3 dimensional objects using light cured materials.
